(19) United States
(12) Patent Application Publication
(10) Pub. No.: US 2026/0184916 A1
(43) Pub. Date: Jul. 2, 2026

(54) Flame-Retardant Polycarbonate Composition

(71) Applicant: Covestro Deutschland AG, Leverkusen (DE)

(72) Inventors: Leith Wang, Shanghai (CN); George Wang, Shanghai (CN)

(21) Appl. No.: 18/838,705

(22) PCT Filed: Feb. 13, 2023
(86) PCT No.: PCT/EP2023/053497

§ 371 Date: Aug. 15, 2024

(30) Foreign Application Priority Data
Feb. 16, 2022 (WO) PCT/CN2022/076396
Mar. 17, 2022 (EP) 22162682.3

(51) Int. Cl. C08L 69/00; C08K 3/22; C08K 5/42

(52) U.S. Cl. CPC C08L 69/00; C08K 3/22; C08K 5/42; C08K 2003/2227; C08L 2201/02; C08L 2205/025; C08L 2205/035

(57) ABSTRACT

The present disclosure relates to a polycarbonate composition including A) from 8 wt. % to 65 wt. % of a copolycarbonate, B) from 30 wt. % to 85 wt. % of a homopolycarbonate; C) from 0.06 wt. % to 0.30 wt. % of a fluorine-containing metal organic sulfonate; D) from 0.8 wt. % to 10 wt. % of polysilsesquioxane; E) from 0.1 wt. % to 0.7 wt. % of a hydrolysis stabilizer; and F) from 0.1 wt. % to 5 wt. % of a hydrolysis stabilizer, relative to the total weight of the composition. The present disclosure also relates to a shaped article made from the composition. The polycarbonate composition according to the present disclosure has a good combination of flame-retardance and heat-resistance.

### CROSS-REFERENCE TO RELATED APPLICATIONS

This application is the United States national phase of International Patent Application No. PCT/EP2023/053497 filed Feb. 13, 2023, and claims priority to International Patent Application No. PCT/CN2022/076396 filed Feb. 16, 2022, and to European Patent Application No. 22162682.3, filed Mar. 17, 2022, the disclosures of which are hereby incorporated by reference in their entireties.

### BACKGROUND

### Technical Field

The present invention relates to a flame-retardant polycarbonate (PC) composition, and a shaped article made from the same.

### Description of Related Art

High heat-resistant polycarbonate copolymers are critical materials for applications where high temperature is created, or high temperature is necessary for processing, typically auto light reflectors, camera flash lenses, medical containers, hot water cups etc. However, high heat-resistant polycarbonate copolymers are intrinsically easy burning, and there is no existing technical solution to make a bromine/chlorine free flame retardant grade. This disadvantage has been limiting their wide application in EEA industry where bromine/chlorine free flame retardant is requested.

Efforts have been made to develop polycarbonate compositions comprising high heat-resistance polycarbonate copolymers with good flame retardant resistance meeting the requirements for various applications such as electrical connector, Printed Circuit Board (PCB) wave soldering, medical devices etc.

DE 4232897 C2 discloses flame-resistant thermoplastic moulding materials having good stability at high processing temperatures and improved surface appearance, comprising 90-99.9 part of dihydroxydiphenylalkane-containing polycarbonate copolymer, 0.1-5 parts of flame retardant additives, and 0.01-5 parts of anti-drip agent such as PTFE.

EP 0410221 B1 discloses a flame-retardant composition comprising A) 5 to 99.5 parts by weight thermoplastic aromatic polycarbonates containing TMC structural units and B) 0.5 to 95 parts by weight, based on 100 parts by weight of A)+B), of phosphorus compounds except for salts of phosphonic acid and salts of phosphoric acid.

Polysilsesquioxanes have attracted strong interests from many global chemical companies, and triggered tremendous investigation in the past decades. Most researches focused on its light diffusion performance.

U.S. Pat. No. 8,927,636 B2 discloses a method for achieving good flame resistance, impact resistance and surface quality by incorporating a metal organic sulfonate, a fluoropolymer, specified silsesquioxane particles and a specified graft copolymer into a polycarbonate resin.

JP 4890766 B2 discloses a light diffusing aromatic polycarbonate resin composition, in which special polyorganosilsesquioxane particles, weight loss thereof at 400-500° C. is 1 percent in (TGA) thermal gravimetric conforming to (B) JIS K7120, have been used as light diffusing agent and added into polycarbonate. The light-diffusing aromatic polycarbonate resin composition exhibits high brightness when used in the direct type backlight light diffusion plate.

Therefore, there is still a need for a polycarbonate composition with a good combination of flame-retardance (for example, V0 performance according to UL94-2015 at 1.5 mm) and heat-resistance (for example, a Vicat softening temperature no less than 152° C.) as well as flame-retardance stability.

### SUMMARY

One object of the present application is thus to provide a polycarbonate composition which has a good combination of flame-retardance (V0 performance according to UL94-2015 at 1.5 mm) and heat-resistance (a Vicat softening temperature no less than 152° C.) as well as flame-retardance stability.

Thus, in a first aspect, the present invention provides a polycarbonate composition comprising the following components A-F, relative to the total weight of the composition:
A) from 8 wt. % to 65 wt. % of a copolycarbonate comprising
i) units of formula (1)

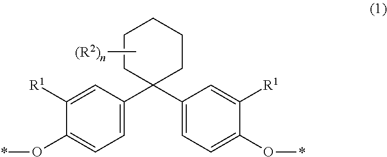

wherein
* indicates the position where formula (1) is connected to the polymer chain,
R¹, each independently, is hydrogen or C₁-C₄ alkyl,
R², each independently, is C₁-C₄ alkyl,
n is 0, 1, 2 or 3, and
ii) units of formula (2):

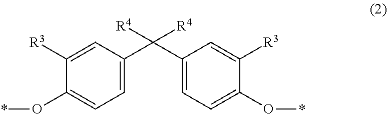

wherein
* indicates the position where formula (2) is connected to the polymer chain,
R³, each independently, is H, linear or branched C₁-C₁₀ alkyl, and
R⁴, each independently, is linear or branched C₁-C₁₀ alkyl;
B) from 30 wt. % to 85 wt. % of a homopolycarbonate comprising units of formula (2) as defined above;
C) from 0.06 wt. % to 0.30 wt. % of a fluorine-containing metal organic sulfonate;
D) from 0.8 wt. % to 10 wt. % of a polysilsesquioxane;
E) from 0.1 wt. % to 0.7 wt. % of an anti-dripping agent; and
F) from 0.1 wt. % to 5 wt. % of a hydrolysis stabilizer, wherein the hydrolysis stabilizer is selected from the group consisting of mineral clays,
wherein the content by weight of the units of formula (1) in the polycarbonate composition is from 5 wt. % to 50 wt. %, relative to the total weight of the composition.

As used herein, the content by weight of the units of formula (1) in the polycarbonate composition (C_{1/C/W}) is calculated as follows:

$${C}_{1 / C / W} = \frac{{C}_{1 / CO / M} \times {M}_{w 1}}{( {C}_{1 / CO / M} \times {M}_{w {1}^{′}} + {C}_{2 / CO / M} \times {M}_{w 2} )} \times {C}_{co / c / w}$$

Wherein
C_{1/C/W} stands for the content by weight of the units of formula (1) in the polycarbonate composition;
C_{I/CO/M} stands for the content by mole of the units of formula (1) in the copolycarbonate;
M_{w1} stands for the molecular weight of the units of formula (1), which is expressed in grams per mole;
M_{w1′} stands for the total molecular weight of the units of formula (1) and —C═O—, which is expressed in grams per mole;
C_{2/CO/M} stands for the content by mole of the units of formula (2) in the copolycarbonate;
M_{w2} stands for the molecular weight of the units of formula (2), which is expressed in grams per mole; and
C_{co/c/w} stands for the content by weight of the copolycarbonate in the polycarbonate composition.

In a second aspect, the present invention provides a shaped article made from a polycarbonate composition according to the present invention.

In a third aspect, the present invention provides a process for preparing the shaped article mentioned before, comprising injection moulding, extrusion moulding, blow moulding or thermoforming the polycarbonate composition according to the present invention.

The inventors have found that with a combination of said copolycarbonate, polysilsesquioxane, fluorine-containing metal organic sulfonate, anti-dripping agent, and a hydrolysis stabilizer, the composition according to the present invention has a good combination of flame-retardance (V0 performance according to UL94-2015 at 1.5 mm), flame-retardance stability (the evaluation results of flame-retardancy for 8 or more batches from 10 batches is the same), and heat-resistance (a Vicat softening temperature no less than 152° C.), even at a thin-wall condition for example at a thickness of 1.5 mm, therefore, it is possible for the composition to be used in applications high heat-resistance and flame retardance required.

Other subjects and characteristics, aspects and advantages of the present invention will emerge even more clearly on reading the description and the examples that follow.

### DETAILED DESCRIPTION

In that which follows and unless otherwise indicated, the limits of a range of values are included within this range, in particular in the expressions “between . . . and . . . ” and “from . . . to . . . ”.

Throughout the present application, the term “comprising” is to be interpreted as encompassing all specifically mentioned features as well as optional, additional, unspecified ones.

Unless defined otherwise, all technical and scientific terms used herein have the same meaning as commonly understood by one of ordinary skill in the art to which the present invention pertains. When the definition of a term in the present description conflicts with the meaning as commonly understood by those skilled in the art the present invention belongs to, the definition described herein shall apply.

Unless otherwise specified, all numerical values expressing amount of ingredients and the like which are used in the description and claims are to be understood as being modified by the term “about”.

### Component A

According to the first aspect, the polycarbonate composition according to the present invention comprises a copolycarbonate as component A.

In the present application, the copolycarbonate refers to the polycarbonate comprising
i) units of formula (1)

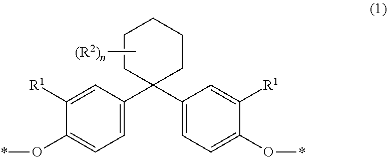

wherein
* indicates the position where formula (1) is connected to the polymer chain,
R¹, each independently, is hydrogen or C₁-C₄ alkyl,
R², each independently, is C₁-C₄ alkyl,
n is 0, 1, 2 or 3, and
ii) units of formula (2):

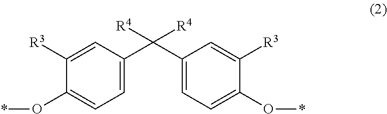

wherein
*indicates the position where formula (2) is connected to the polymer chain,
R³, each independently, is H, linear or branched C₁-C₁₀ alkyl, preferably, H, linear or branched C₁-C₄ alkyl, and
R⁴, each independently, is linear or branched C₁-C₁₀ alkyl, preferably linear or branched C₁-C₄ alkyl.

The units of formula (1) can be derived from a diphenol of formula (1′):

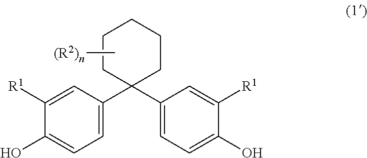

wherein
R¹, each independently, represents hydrogen or C₁-C₄ alkyl,
R², each independently, represents C₁-C₄ alkyl,
n represents 0, 1, 2 or 3.

Preferably, the unit of formula (1) has the following formula (1a),

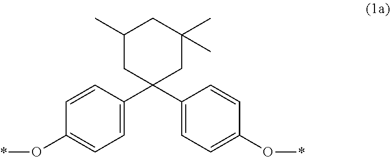

wherein * indicates the position where formula (1a) is connected to the polymer chain, i.e., the unit of formula (1) is derived from bis(4-hydroxyphenyl)-3,3,5-trimethylcyclohexane (BPTMC) having the formula (1′a):

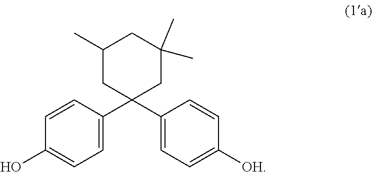

The units of formula (2) can be derived from a diphenol of formula (2′):

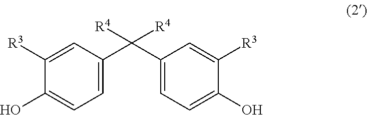

wherein
R³, each independently, represents H, linear or branched C₁-C₁₀ alkyl,
R⁴, each independently, represents linear or branched C₁-C₁₀ alkyl.

Preferably, the unit of formula (2) has the following formula (2a),

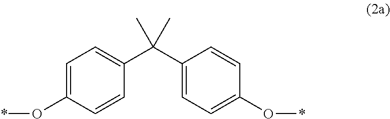

wherein * indicates the position where formula (2a) is connected to the polymer chain,
i.e., the unit of formula (2) is derived from bisphenol A, i.e. the diphenol of formula (2′a).

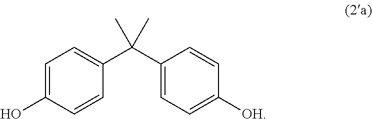

Preferably, the copolycarbonate comprises units derived from bis(4-hydroxyphenyl)-3,3,5-trimethylcyclohexane (BPTMC) and bisphenol A.

Preferably, the copolycarbonate does not comprise units derived from a diphenol other than a diphenol of formula (1′) and a diphenol of formula (2′).

Preferably, the copolycarbonate does not comprise units derived from a diphenol other than bis(4-hydroxyphenyl)-3,3,5-trimethylcyclohexane (BPTMC) and bisphenol A.

The diphenols of formula (1′) and formula (2′) are known and can be prepared by processes known from literatures (for example H. J. Buysch et al., Ullmann's Encyclopedia of Industrial Chemistry, VCH, New York 1991, 5th Ed., Vol. 19, p. 348).

Preferably, the mole content of the units of the formula (1) in the copolycarbonate is 20-90 mol %, more preferably 50-90 mol %, and the mole content of the units of the formula (2) in the copolycarbonate is 10-80 mol %, more preferably 10-50 mol %, both based on the total mole number of units of formula (1) and formula (2).

The copolycarbonate used in the composition according to the present invention is commercially available or can be produced by a process known in the art. For example, the copolycarbonate used in the composition according to the present invention can be produced by an interfacial process. In particular, the diphenols of the formula (1′) and (2′) and optional branching agents are dissolved in aqueous alkaline solution and reacted with a carbonate source, such as phosgene, optionally dissolved in a solvent, in a two-phase mixture comprising an aqueous alkaline solution, an organic solvent and a catalyst, preferably an amine compound. The reaction procedure can also be conducted in a multistep process.

Such processes for the preparation of copolycarbonate are known in principle as two-phase interfacial processes, for example from H. Schnell, Chemistry and Physics of Polycarbonates, Polymer Reviews, Vol. 9, Interscience Publishers, New York 1964, page 33 et seq., and on Polymer Reviews, Vol. 10, “Condensation Polymers by Interfacial and Solution Methods”, Paul W. Morgan, Interscience Publishers, New York 1965, Chapter VIII, page 325, and the underlying conditions are therefore familiar to the person skilled in the art.

The concentration of the diphenols in the aqueous alkaline solution is from 2 wt. % to 25 wt. %, preferably from 2 wt. % to 20 wt. %, more preferably from 2 wt. % to 18 wt. % and even more preferably from 3 wt. % to 15 wt. %. The aqueous alkaline solution consists of water in which hydroxides of alkali metals or alkaline earth metals are dissolved. Sodium and potassium hydroxides are preferred.

The concentration of the amine compound is from 0.1 mol % to 10 mol %, preferably 0.2 mol % to 8 mol %, particularly preferably 0.3 mol % to 6 mol % and more particularly preferably 0.4 mol % to 5 mol %, relative to the mole amount of diphenol used.

The carbonate source is phosgene, diphosgene or triphosgene, preferably phosgene. Where phosgene is used, a solvent may optionally be dispensed with and the phosgene may be passed directly into the reaction mixture.

Tertiary amines, such as triethylamine or N-alkylpiperidines, may be used as a catalyst. Suitable catalysts are trialkylamines and 4-(dimethylamino)pyridine. Triethylamine, tripropylamine, triisopropylamine, tributylamine, trisobutylamine, N-methylpiperidine, N-ethylpiperidine and N-propylpiperidine are particularly suitable.

Halogenated hydrocarbons, such as methylene chloride, chlorobenzene, dichlorobenzene, trichlorobenzene or mixtures thereof, or aromatic hydrocarbons, such as, toluene or xylenes, are suitable as an organic solvent. The reaction temperature may be from −5° C. to 100° C., preferably from 0° C. to 80° C., particularly preferably from 10° C. to 70° C. and very particularly preferably from 10° C. to 60° C. The preparation of the copolycarbonates by the melt transesterification process, in which the diphenols are reacted with diaryl carbonates, generally diphenyl carbonate, in the presence of catalysts, such as alkali metal salts, ammonium or phosphonium compounds, in the melt, is also possible.

The melt transesterification process is described, for example, in Encyclopedia of Polymer Science, Vol. 10 (1969), Chemistry and Physics of Polycarbonates, Polymer Reviews, H. Schnell, Vol. 9, John Wiley and Sons, Inc. (1964), and DE 1031512 A.

In the transesterification process the aromatic dihydroxy compounds already described in the case of the phase boundary process are transesterified with carbonic acid diesters with the aid of suitable catalysts and optionally further additives in the melt. The reaction of the aromatic dihydroxy compound and of the carbonic acid diester to give the copolycarbonate can be carried out batchwise or preferably continuously, for example in stirred vessels, thin-film evaporators, falling-film evaporators, stirred vessel cascades, extruders, kneaders, simple disc reactors and high-viscosity disc reactors.

Preferably, the copolycarbonate is selected from block copolycarbonates and random copolycarbonates. More preferably, the copolycarbonate is selected from random copolycarbonates.

Advantageously, the copolycarbonate has a weight average molecular weight (Mw) ranging from 16000 g/mol to 40000 g/mol, preferably from 17000 g/mol to 32000 g/mol, as determined by Gel Permeation Chromatography (GPC) in methylene chloride at 25° C. using a polycarbonate standard with an UV-IR detector.

As an example for commercial products of the copolycarbonate suitable for the composition according to the present invention, mention can be made of the products sold under the name APEC® by the company Covestro Polymer (China), which are polycarbonate copolymers made from the copolymerization of carbonyl chloride with bisphenol A (BPA) and 3,3,5-trimethyl-1,1-bis(4-hydroxyphenyl) cyclohexane (BPTMC).

The copolycarbonate is present in the polycarbonate composition according to the invention in an amount ranging from 8 wt. % to 65 wt. %, more preferably from 10 wt. % to 60 wt. %, even more preferably 40 wt. % to 60 wt. %, relative to the total weight of the composition according to the present invention.

### Component B

According to the first aspect, the polycarbonate composition according to the present invention comprises a homopolycarbonate comprising units of formula (2) as component B. In the present application, the homopolycarbonate refers to the polycarbonate comprising units of formula (2) as defined above.

The units of formula (2) are derived from a diphenol of formula (2′):

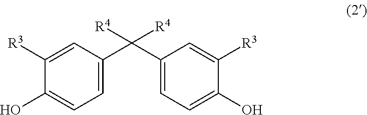

wherein
R³, each independently, represents H, linear or branched C₁-C₁₀ alkyl, preferably linear or branched C₁-C₆-alkyl, more preferably linear or branched C₁-C₄ alkyl, even more preferably H or methyl, and
R⁴, each independently, represents linear or branched C₁-C₁₀ alkyl, preferably linear or branched C₁-C₆ alkyl, more preferably linear or branched C₁-C₄-alkyl, even more preferably methyl.

Preferably, the unit of formula (2) is derived from the diphenol of formula (2′a), i.e. bisphenol A.

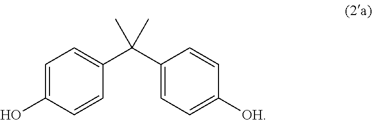

The homopolycarbonate used in the composition according to the present invention is commercially available or can be produced by a process known in the art. For example, the homopolycarbonate can be produced by referring to the preparation process described with respect to component A.

Preferably, the homopolycarbonate has a weight average molecular weight (Mw) ranging from 22,000 g/mol to 30,000 g/mol, ranging from 24,000 g/mol to 28,000 g/mol, as determined by Gel Permeation Chromatography (GPC) in methylene chloride at 25° C. using a polycarbonate standard with a UV-IR detector.

As commercial products of homopolycarbonates suitable for use in the composition according to the present invention, mention can be made of Makrolon® 2400, Makrolon® 2600, and Makrolon® 2800 sold by the company Covestro Polymer (China).

The homopolycarbonate is present in the polycarbonate composition according to the invention in an amount ranging from 30 wt. % to 85 wt. %, more preferably 33 wt. % to 83 wt. %, relative to the total weight of the composition according to the present invention.

### Component C

The polycarbonate compositions according to the present invention comprise a fluorine-containing metal organic sulfonate as component C.

The incorporation of fluorine-containing metal organic sulfonate improves the flame resistance of the polycarbonate compositions of the present invention.

Examples of the metals contained in the fluorine-containing metal organic sulfonates include alkali metals such as lithium (Li), sodium (Na), potassium (K), rubidium (Rb) and cesium (Cs); alkali earth metals such as magnesium (Mg), calcium (Ca), strontium (Sr) and barium (Ba); and aluminum (Al), titanium (Ti), iron (Fe), cobalt (Co), nickel (Ni), copper (Cu), zinc (Zn), zirconium (Zr), molybdenum (Mo), etc. Of those, an alkali metal or an alkali earth metal is preferable.

Preferably, the metal salt of fluorine-containing organic sulfonic acid contained is selected from the group consisting of alkali metal salts and alkaline earth metal salts, even more preferable is an alkali metal salt, wherein the metal is preferably sodium, potassium or cesium. Examples of the metal organic sulfonates include lithium (Li) fluorine-containing organic sulfonate, sodium (Na) fluorine-containing organic sulfonate, potassium (K) fluorine-containing organic sulfonate, rubidium (Rb) fluorine-containing organic sulfonate, cesium (Cs) fluorine-containing organic sulfonate, magnesium (Mg) fluorine-containing organic sulfonate, calcium (Ca) fluorine-containing organic sulfonate, strontium (Sr) fluorine-containing organic sulfonate, barium (Ba) fluorine-containing organic sulfonate, etc. Of those, in particular, alkali metal fluorine-containing organic sulfonates are preferable, including sodium (Na) fluorine-containing organic sulfonate, potassium (K) fluorine-containing organic sulfonate compounds, cesium (Cs) fluorine-containing organic sulfonate compounds, etc.

Preferred examples of the metal salts of fluorine-containing organic sulfonic acid include metal salts of fluorine-containing aliphatic sulfonic acid, metal salts of fluorine-containing aliphatic sulfonimide.

Specific examples of preferred fluorine-containing metal organic sulfonates include:
i) metal salts of fluorine-containing aliphatic sulfonic acids such as:
alkali metal salts of fluorine-containing aliphatic sulfonic acids having at least one C—F bond in the molecule such as potassium perfluorobutane sulfonate, lithium perfluorobutane sulfonate, sodium perfluorobutane sulfonate, cesium perfluorobutane sulfonate, lithium trifluoromethane sulfonate, sodium trifluoromethane sulfonate, potassium trifluoromethane sulfonate, potassium perfluoroethane sulfonate and potassium perfluoropropane sulfonate;
alkali earth metal salts of fluorine-containing aliphatic sulfonic acids having at least one C—F bond in the molecule such as magnesium perfluorobutane sulfonate, calcium perfluorobutane sulfonate, barium perfluorobutane sulfonate, magnesium trifluoromethane sulfonate, calcium trifluoromethane sulfonate, and barium trifluoromethane sulfonate;
alkali metal salts of fluorine-containing aliphatic disulfonic acids having at least one C—F bond in the molecule such as disodium perfluoromethane disulfonate, dipotassium perfluoromethane disulfonate, sodium perfluoroethane disulfonate, dipotassium perfluoroethane disulfonate, dipotassium perfluoropropane disulfonate, dipotassium perfluoroisopropane disulfonate, disodium perfluorobutane disulfonate, potassium perfluorobutane disulfonate, dipotassium perfluorobutane disulfonate and dipotassium perfluorooctane disulfonate;
ii) metal salts of fluorine-containing aliphatic sulfonimides such as:
alkali metal salts of fluorine-containing aliphatic disulfonimides having at least one C—F bond in the molecule such as lithium bis(perfluoropropanesulfonyl)imide, sodium bis(perfluoropropanesulfonyl)imide, potassium bis(perfluoropropanesulfonyl)imide, lithium bis(perfluorobutanesulfonyl)imide, sodium bis(perfluorobutanesulfonyl)imide, potassium bis(perfluorobutanesulfonyl)imide, potassium trifluoromethane(pentafluoroethane)sulfonylimide, sodium trifluoromethane(nonafluorobutane)sulfonylimide, potassium trifluoromethane(nonafluorobutane)sulfonylimide, trifluoromethane, etc.;
alkali metal salts of cyclic fluorine-containing aliphatic sulfonimides having at least one C—F bond in the molecule such as lithium cyclo-hexafluoropropane-1,3-bis(sulfonyl)imide, sodium cyclo-hexafluoropropane-1,3-bis(sulfonyl)imide, and potassium cyclo-hexafluoropropane-1,3-bis(sulfonyl)imide.

Among those, more preferable are metal salts of fluorine-containing aliphatic sulfonic acids.

As the metal salt of fluorine-containing aliphatic sulfonic acids, preferable are alkali metal salts of fluorine-containing aliphatic sulfonic acids having at least one C—F bond in the molecule, particularly preferable are alkali metal salts of perfluoroalkane sulfonic acids. Specifically, potassium perfluorobutane sulfonate etc. are preferable.

As commercial products of metal salts of fluorine-containing organic sulfonic acid, mention can be made of potassium perfluorobutane sulfonate, sold under the trade name Bayowet C4 by LANXESS AG Germany.

The metal salt of fluorine-containing organic sulfonic acid is present in the polycarbonate composition according to the invention in an amount ranging from 0.06 wt. % to 0.30 wt. %, preferably from 0.1 wt. % to 0.2 wt. %, relative to the total weight of the composition.

Mechanical properties such as impact resistance, heat-resistance, and good electric characteristics, which a polycarbonate resin has, are not negatively influenced by addition of such metal salt of fluorine-containing organic sulfonic acid.

### Component D

The polycarbonate compositions according to the present invention comprise at least one polysilsesquioxane as component D.

The polysilsesquioxane, as used herein, has a trifunctional siloxane unit represented by RSiO_{1.5} (R is hydrogen or a monovalent organic group) (hereinafter, it may be referred to as a “T unit”), and contains the unit in an amount of 90% by mol or more, preferably of 95% by mol or more, more preferably of 100% by mol of the total siloxane units (M unit, D unit, T unit, Q unit).

Meanwhile, the M unit represents a monofunctional siloxane unit represented by R₃SiO_{0.5} (R is hydrogen or a monovalent organic group), the D unit represents a bifunctional siloxane unit represented by R₂SiO_{1.0} (R is hydrogen or a monovalent organic group), and the Q unit represents a tetrafunctional siloxane unit represented by SiO_{2.0}.

The polysilsesquioxane may contain an M unit, in addition to the T unit.

Examples of R bonded to the polysilsesquioxane include hydrogen, C₁-C₁₂ alkyl, C₂-C₁₂ alkenyl, C₁-C₁₂ alkoxy, C₁-C₁₂ acyl, C₃-C₈ cycloalkyl, and phenyl. Preferably, R is selected from hydrogen, C₁-C₆ alkyl, C₁-C₆ alkenyl, C₁-C₆ alkoxy, and phenyl. More preferably, R is selected from alkyl groups having 1 to 6 carbon atoms such as a methyl group, an ethyl group, a propyl group, a butyl group, and a hexyl group. Of those, as the organic group R, a methyl group is preferable, for the purpose of the present invention. Preferably, polymethylsilsesquioxane is used as the polysilsesquioxane, alone or in combination with other polysilsesquioxanes, particularly preferred alone.

Preferable polysilsesquioxanes as described above can be produced by a publicly known method. For example, as described in JP-A-01-217039, JP-A-5-125187 or JP-A-6-263875, the polysilsesquioxane is obtained by hydrolyzing organosilane under an acidic condition, adding and mixing an alkali aqueous solution to aqueous or aqueous/organic solvent of organosilanetriol, and leaving the product in a static state to thereby polycondensate the organosilanetriol.

As examples of commercial products of polysilsesquioxanes, mention can be made of polymethylsilsesquioxane sold under the trade name Ganzpearl SI-020 by GANZ CHEMICAL CO., LTD and under the trade name ABC E+308 by ABC NANOTECH CO., LTD.

Advantageously, the polysilsesquioxane is present in the polycarbonate composition according to the invention in an amount ranging from 0.8 wt. % to 10 wt. %, preferably from 1 wt. % to 9 wt. %, relative to the total weight of the polycarbonate composition.

### Component E

The polycarbonate compositions according to the present invention comprise at least one anti-dripping agent as component E.

Preferably, the at least one anti-dripping agent used is selected from the group consisting of fluorinated polyolefins.

The fluorinated polyolefins are known (see “Vinyl and Related Polymers” by Schildknecht, John Wiley & Sons, Inc., New York, 1962, pages 484-494; “Fluoropolymers” by Wall, Wiley-Interscience, John Wiley & Sons, Inc., New York, Volume 13, 1970, pages 623-654; “Modern Plastics Encyclopedia”, 1970-1971, Volume 47, No. 10 A, October 1970, McGraw-Hill, Inc., New York, pages 134 and 774; “Modern Plastics Encyclopaedia”, 1975-1976, October 1975, Volume 52, No. 10 A, McGraw-Hill, Inc., New York, pages 27, 28 and 472 and U.S. Pat. Nos. 3,671,487, 3,723,373 and 3,838,092).

Preferably, the anti-dripping agent is selected from the group consisting of polytetrafluoroethylene, polyvinylidene fluoride, tetrafluoroethylene/hexafluoropropylene copolymer and ethylene/tetrafluoroethylene copolymer. More preferably, polytetrafluoroethylene (PTFE) is used as anti-dripping agent.

Polytetrafluoroethylene can be prepared by known processes, for example by polymerization of tetrafluoroethylene in an aqueous medium with a free radical-forming catalyst, for example sodium, potassium or ammonium peroxodisulfate, at pressures of from 7 to 71 kg/cm² and at temperatures of from 0 to 200° C., preferably at temperatures of from 20 to 100° C., for further details see e.g. U.S. Pat. No. 2,393,967 A.

Preferably, the fluorinated polyolefins have glass transition temperatures of over −30° C., generally over 100° C., fluorine contents of preferably from 65 to 76 wt. %, in particular from 70 to 76 wt. % (with the fluorinated polyolefins as 100 wt. %), mean particle diameters d₅₀ of from 0.05 to 1,000 m, preferably from 0.08 to 20 μm.

For the purpose of the present invention, the d₅₀ average value of the particle size indicates a particle size, such as 50 weight percent of the relevant material have a larger particle size and 50 weight percent have a smaller particle size of the average value. The d₅₀ average size of the particles in the composition of the present invention can be determined via a method known to the person skilled in the art, for example the d₅₀ value of the PTFE polymer particle size is measured via light scattering techniques (dynamic or laser) using the respective equipment, for example available from the companies Malvern (e.g. Mastersizer® Micro or 3000) or Coulter (e.g. LS 230®), as notably described in the method ISO 13320-1:2020, in EP 1279694 A and in WO 2014/037375 A1. Laser light scattering, based on the light diffraction on the particles, is a suitable technique that can be applied to this kind of powder for determining particle size distribution. In particular the analysis can be performed on dry powder (for instance using a Coulter LS 13320® instrument) or on the powder suspended into a water solution of apposite dispersant (a suitable apparatus is Coulter LS 230®).

Preferably, the fluorinated polyolefins have a density of from 1.2 to 2.3 g/cm³, as measured according to the ASTM D1895: 2017.

More preferably, the fluorinated polyolefins used according to the invention have mean particle diameters of from 0.05 to 20 m, preferably from 0.08 to 10 m, and density of from 1.2 to 1.9 g/cm³.

Suitable fluorinated polyolefins which can be used in powder form are tetrafluoroethylene polymers having mean particle diameters of from 100 to 1000 m and densities of from 2.0 g/cm 3 to 2.3 g/cm³.

As an example of commercial products of polytetrafluoroethylene, mention can be made to those sold under the trade name Teflon® by DuPont. A master batch of polytetrafluoroethylene and styrene-acrylonitrile (SAN) in a weight ratio of 1:1, for example, ADS 5000 available from Chemical Innovation Co., Ltd., and POLYB FS-200 available from Han Nanotech Co., Ltd, can also be used.

The anti-dripping agent is present in the polycarbonate composition according to the invention in an amount ranging from 0.1 wt. % to 0.7 wt. %, preferably from 0.2 wt. % to 0.6 wt. %, more preferably from 0.2 wt. % to 0.5 wt. %, relative to the total weight of the polycarbonate composition.

### Component F

The polycarbonate composition according to the present invention comprise at least one hydrolysis stabilizer as component F, wherein the hydrolysis stabilizer is selected from the group consisting of mineral clays.

“Hydrolysis stabilizer” according to the present invention is understood to mean a substance improving the resistance to hydrolysis of polycarbonate.

As examples of mineral clays, mention can be made of boehmite, gibbsite, diaspore, kaolin (e.g., kaolinite, pyrophyllite), smectite (e.g. montmorillonite, nontronite, saponite), talc, etc.

More preferably, the hydrolysis stabilizer is selected from the group consisting of boehmite, kaolin, talc, citric acid and combinations thereof. Even more preferably, the hydrolysis stabilizer is boehmite.

As commercial products for hydrolysis stabilizers, mention can be made to Boehmite sold under the trade name Pural® 200 by Sasol Germany GmbH, kaolin sold under the trade name Polyfil HG90 by KaMin LLC, talc sold under the trade name HTP® Ultra 5C by IMIFABI SPA, citric acid sold under the trade name Citric Acid Anhydrous by Weifang Ensign Industry Co., Ltd.

The hydrolysis stabilizer is present in the polycarbonate composition according to the invention in an amount ranging from 0.1 wt. % to 5 wt. %, preferably from 0.1 wt. % to 1 wt. %, preferably from 0.2 wt. % to 0.6 wt. %, relative to the total weight of the polycarbonate composition.

Component G In addition to components A-F mentioned above, the polycarbonate compositions according to the present invention can optionally comprise as component G one or more additional additives conventionally used in polymer compositions in conventional amounts. Such additives are lubricants, demoulding agents (e.g. pentaerythritol tetrastearate (PETS), glycerine monostearate (GMS), their carbonates), antioxidants, dyes, pigments, UV absorbers, impact modifiers (such as ABS (acrylonitrile-butadiene-styrene), MBS (methyl methacrylate-butadiene-styrene)), flame-retardants other than the metal salt of fluorine-containing organic sulfonic acid.

The person skilled in the art can select the type and the amount of the additional additives so as to not significantly adversely affect the desired properties of the polycarbonate composition according to the present invention.

For example, in some embodiments, the composition according to the present invention comprises a metal salt of aromatic sulfonic acid as flame-retardant.

Preferably, the metal salt of aromatic sulfonic acid is selected from alkali metal salts of aromatic sulfonates having at least one aromatic group in the molecule such as dipotassium diphenylsulfone-3,3′-disulfonate, potassium diphenylsulfone-3-sulfonate, sodium benzene sulfonate, sodium (poly)styrene sulfonate, sodium paratoluene sulfonate, sodium (branched)dodecylbenzene sulfonate, sodium trichlorobenzene sulfonate, potassium benzene sulfonate, potassium styrene sulfonate, potassium (poly)styrene sulfonate, potassium paratoluene sulfonate, potassium (branched)dodecylbenzene sulfonate, potassium trichlorobenzene sulfonate, cesium benzene sulfonate, cesium (poly)styrene sulfonate, cesium paratoluene sulfonate, cesium (branched)dodecylbenzene sulfonate, and cesium trichlorobenzene sulfonate.

More preferably, the metal salt of aromatic sulfonic acid is selected from alkali metal salts of diphenylsulfone-sulfonic acid such as dipotassium diphenylsulfone-3,3′-disulfonate, and potassium diphenylsulfone-3-sulfonate.

As commercial products of metal salts of aromatic sulfonic acid, mention can be made of potassium diphenylsulfon-3-sulfonate, sold under the trade name KSS-FR® by Arichem LLC.

Advantageously, if present, the metal salts of aromatic sulfonic acid are present in the polycarbonate composition in an amount of no more than 0.5 wt. %, relative to the total weight of the composition.

Preferably, the flame-retardant polycarbonate composition according to the present invention comprises, relative to the total weight of the composition:
A) 10-60 wt. % of a copolycarbonate comprising
i) 50-90 mol % of units of formula (1a)

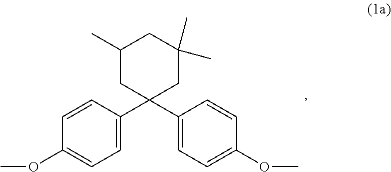

ii) 10-40 mol % of units of formula (2a):

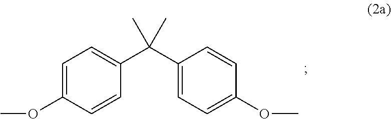

wherein the mol % is calculated based on the total mole number of units of formula (l a) and formula (2a), and
B) from 33 wt. % to 83 wt. % of a homopolycarbonate comprising units of formula (2a),
C) from 0.1 wt. % to 0.2 wt. % of a fluorine-containing metal organic sulfonate, wherein at least potassium perfluorobutane sulfonate is contained as fluorine-containing metal organic sulfonate, more preferably the fluorine-containing metal organic sulfonate is potassium perfluorobutane sulfonate;
D) from 1 wt. % to 9 wt. % of a polysilsesquioxane, wherein polymethylsilsesquioxane is contained as polysilsesquioxane, more preferably the polysilsesquioxane is polymethylsilsesquioxane;
E) from 0.2 wt. % to 0.6 wt. % of an anti-dripping agent, wherein polytetrafluoroethylene is contained as anti-dripping agent, more preferably the anti-dripping agent is polytetrafluorethylene; and
F) from 0.2 wt. % to 0.6 wt. % of boehmite,
wherein the content by weight of the units of formula (1a) in the polycarbonate composition is 6.5-45 wt. %, relative to the total weight of the composition.

### Preparation of the Polycarbonate Composition

The polycarbonate compositions according to the present invention can be in the form of, for example, pellets, and can be prepared by a variety of methods involving intimate admixing of the materials desired in the composition.

For example, the materials desired in the composition are first blended in a high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding it directly into the extruder at the throat and/or downstream through a side stuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets can be one-fourth inch long or less as described. Such pellets can be used for subsequent molding, shaping or forming.

Melt blending methods are preferred due to the availability of melt blending equipment in commercial polymer processing facilities.

Illustrative examples of equipment used in such melt processing methods include co-rotating and counter-rotating extruders, single screw extruders, co-kneaders, and various other types of extrusion equipment.

The temperature of the melt in the processing is preferably minimized in order to avoid excessive degradation of the polymers. It is often desirable to maintain the melt temperature between 230° C. and 350° C. in the molten resin composition, although higher temperatures can be used provided that the residence time of the resin in the processing equipment is kept short.

In some cases, the melting composition exits from a processing equipment such as an extruder through small exit holes in a die. The resulting strands of the molten resin are cooled by passing the strands through a water bath. The cooled strands can be chopped into small pellets for packaging and further handling.

### Shaped Articles

The polycarbonate composition according to the present invention can be used, for example, for the production of various types of shaped articles.

The present invention also provides a shaped article made from a polycarbonate composition according to the present invention.

As examples of such shaped articles mention can be made of, for example, all kinds of housing parts, e.g. for domestic appliances such as juice presses, coffee machines and mixers, or for medical devices; electrical conduits; electrical connectors; electrical and electronic parts such as switches, plugs and sockets; and body parts or interior trim for commercial vehicles.

### Preparation of Shaped Articles

The polycarbonate composition according to the present invention can be processed into shaped articles by a variety of means such as injection moulding, extrusion moulding, blow moulding or thermoforming to form shaped articles.

The present invention provides a process for preparing the shaped article made from a composition according to the present invention, comprising injection moulding, extrusion moulding, blow moulding or thermoforming the polycarbonate composition according to the present invention.

The examples which follow serve to illustrate the invention in greater detail.

### EXAMPLES

### Materials Used

### Component A

CoPC: commercially available from the company Covestro Polymer (China), a copolycarbonate based on 70 mol % of 3,3,5-trimethyl-1,1-bis(4-hydroxyphenyl)cyclohexane (bisphenol TMC) units and 30 mol % of bisphenol A units, based on the total amount of bisphenol units, with a MVR of 7 cm³/10 min, as measured at 330 C, 1.2 kg according to ISO 1133: (2011), and a weight average molecular weight of about 30000 g/mol, as determined by means of Gel Permeation Chromatography (GPC) in methylene chloride at 25° C. using a polycarbonate standard.

### Component B

PC: commercially available from the company Covestro polymer (China), a linear polycarbonate based on bisphenol A have a weight average molecular weight of about 28000 g/mol, as determined by means of Gel Permeation Chromatography (GPC) in methylene chloride at 25° C. using a polycarbonate standard.

### Component C

C1: Potassium perfluorobutane sulfonate, available as Bayowet C4 from LANXESS.

### Component D

D1: polymethylsilsesquioxane with a mean particle diameter: 0.8 μm determined by MALVERN MS2000, available as ABC E+308 from ABC NANOTECH CO., LTD.

### Component E

E1: a masterbatch of polytetrafluoroethylene and styrene-acrylonitrile (SAN) in a weight ratio of 1:1, available as ADS 5000 from Chemical Innovation Co., Ltd. Thailand.

### Component F

F1: boehmite, available as Pural® 200 from Sasol Germany GmbH.

### Component G

G1: pentaerythritol tetrastearate (PETS), a demoulding agent, available as Faci L348 from the company FACI.

G2: mixture of 80 wt. % of Irgafos® 168 (tris(2,4-ditert-butylphenyl) phosphite) and 20 wt. % of Irganox® 1076 (2,6-ditert-butyl-4-(octadecanoxycarbonylethyl)phenol, available as Irganox® B900 from BASF (China) Company Limited.

G3: a UV filter, 2,2′-methylenebis(6-(benzotriazol-2-yl)-4-tert-octylphenol, available as TINUVIN 360 from BASF.

G4: potassium diphenylsulfone-3-sulfonate, available as Arichem KSS-FR® from Arichem.

G5: ABS (acrylonitrile-butadiene-styrene), available as P60 from Styrolution South East Asia Pte Ltd., Singapore.

G6: MBS (methyl methacrylate-butadiene-styrene), available as M732 from Kaneka.

### Test Methods

The physical properties of the composition according to the examples were tested as follows.

The IZOD notched impact strength was measured on test bars of dimensions 80 mm×10 mm×3 mm in accordance with ISO 180/IA:2000.

Vicat softening temperature was determined on bars of dimensions 80 mm×10 mm×4 mm according to ISO 306: 2013 (50N; 120 K/h).

The flame retardance was evaluated on 127 mm×12.7 mm×1.5 mm bars according to UL94-2015.

The flame retardance stability was determined based on the results of flame retardance. If the evaluation results of flame-retardance for 8 or more batches from 10 batches is V0, then the stability is positive (+), and if the evaluation results of flame-retardancy for less than 8 batches from 10 batches is V0, then the stability is negative (−).

### Comparative Examples 1-17 (CE1-CE17)

The materials listed in Table 1 were compounded on a twin-screw extruder (ZSK-25) (Werner and Pfleider) at a speed of rotation of 225 rpm, a throughput of 20 kg/h, and a machine temperature of 260° C., and granulated. All parts by weight are calculated according to the material used in all inventive examples and comparative examples.

The granules were processed into corresponding test specimens on an injection moulding machine with a melting temperature of 260° C. and a mold temperature 80° C.

As used herein, the content by weight of BPTMC unit (C_{BPTMC/C/CW}) in a polycarbonate composition is calculated as follows:

$${C}_{BPTMC / C / W} = \frac{{C}_{BPTMC / CO / M} \times {M}_{wBPTMC}}{( {C}_{BPTMC / CO / M} \times {M}_{{wBPTMC}^{′}} + {C}_{BPA / CO / M} \times {M}_{wBPA} )} \times {C}_{co / c / w}$$

Wherein C_{BPTMC/C/W} stands for the content by weight of BPTMC unit in the polycarbonate composition;
C_{BPTMC/CO/M} stands for the content by mole of BPTMC unit in a copolycarbonate;
M_{wBPTMC} stands for the molecular weight of BPTMC unit, which is expressed in grams per mole;
M_{wBPTMC′} stands for the total molecular weight of BPTMC unit and —C═O—, which is expressed in grams per mole;
C_{BPA/CO/M} stands for the content by mole of BPA unit in the copolycarbonate;
M_{wBPA} stands for the molecular weight of BPA unit and —C═O—, which is expressed in grams per mole; and
C_{co/c/w} stands for the content by weight of the copolycarbonate in the polycarbonate composition.

Taking comparative example 2 as an example, the molar content of BPTMC unit is 70 mol % and the molar content of BPA unit is 30 mol % in CoPC, the molecular weight of BPTMC unit is 308 g/mol, the total molecular weight of BPTMC unit and —C═O— is 336 g/mol, the molecular weight of BPA unit (including —C═O—) is 254 g/mol, CoPC is present in an amount of 10 wt. % in the polycarbonate composition, thus the content by weight of BPTMC unit in inventive example 1 is:

$$\frac{70 mol \% \times 308 g / mol}{( 70 mol \% \times 336 g / mol + 30 mol \% \times 254 g / mol )} \times 10 wt . \% = 6.9 wt . \%$$

The physical properties of compositions obtained were tested and the results were summarized in Table 1.

It can be seen from Table 1 that composition of comparative example 1 not comprising CoPC, polymethylsilsesquioxane, and boehmite demonstrates a Vicat softening temperature less than 152° C.

Compositions of comparative examples 2-6 not comprising polymethylsilsesquioxane and boehmite failed in the flame retardance test.

Compositions of comparative examples 7-9 not comprising polymethylsilsesquioxane do not show good flame retardance stability.

Composition of comparative example 10 not comprising polymethylsilsesquioxane shows a flame retardant level of V1.

Composition of comparative example 11 not comprising polymethylsilsesquioxane failed in the flame retardance test.

Compositions of comparative examples 12-16 not comprising boehmite do not show good flame retardance stability.

Composition of comparative example 17 not comprising boehmite shows a flame retardant level of V1.

TABLE 1

| | | CE1 | CE2 | CE3 | CE4 | CE5 | CE6 | CE7 | CE8 | CE9 | CE10 | CE11 | CE12 | CE13 | CE14 | CE15 | CE16 | CE17 |
|---|---|---|---|---|---|---|---|---|---|---|---|---|---|---|---|---|---|---|
| Component | | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % |
| A | CoPC | − | 10 | 20 | 30 | 40 | 50 | 10 | 20 | 30 | 40 | 50 | 50 | 20 | 30 | 40 | 50 | 60 |
| B | PC | 98.6 | 88.6 | 72.6 | 68.6 | 58.6 | 48.6 | 88.2 | 78.2 | 68.2 | 58.2 | 48.2 | 83.6 | 73.6 | 63.6 | 53.6 | 43.6 | 33.6 |
| C | Bayowet C4 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| D | E + 308 | − | − | − | − | − | − | − | − | − | − | − | 5 | 5 | 5 | 5 | 5 | 5 |
| E | ADS5000 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| G | Pura200 | − | − | − | − | − | − | 0.4 | 0.4 | 0.4 | 0.4 | 0.4 | − | − | − | − | − | − |
| G1 | Faci L348 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| G2 | B900 | 0.2 | 0.2 | 0.2 | 02 | 0.2 | 0.2 | 0.2 | 0.2 | 0.2 | 0.2 | 0.2 | 0.2 | 0.2 | 0.2 | 0.2 | 0.2 | 0.2 |
| G3 | TIN360 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |

| | | | | | | | | | | | | | | | | | |
|---|---|---|---|---|---|---|---|---|---|---|---|---|---|---|---|---|---|
| BPTMC | 0 | 6.9 | 13.8 | 20.8 | 27.7 | 34.6 | 6.9 | 13.8 | 20.8 | 27.7 | 34.6 | 6.9 | 13.8 | 20.8 | 27.7 | 34.6 | 41.5 |
| content (wt %) | | | | | | | | | | | | | | | | | |

Properties

| | | | | | | | | | | | | | | | | | |
|---|---|---|---|---|---|---|---|---|---|---|---|---|---|---|---|---|---|
| Vicat softening | 145 | 152 | 157 | 164 | 170 | 176 | 152 | 158 | 163 | 170 | 176 | 152 | 158 | 163 | 170 | 376 | 183 |
| temperatur (□C) | | | | | | | | | | | | | | | | | |
| Izod notched | 60 | 12C | 10C | 8.4C | 7.5 | 6.7 | 12C | 9.6C | 8.7C | 7.7C | 6.6C | 62P | 60P | 45P | 30C | 23C | 11C |
| impact | | | | | | | | | | | | | | | | | |
| strength [KJ/m²] | | | | | | | | | | | | | | | | | |
| Flame-retardant | V0 | Fail | Fail | Fail | Fail | Fail | V0 | V0 | V0 | V1 | Fail | V0 | V0 | V0 | V0 | V0 | V1 |
| level at 1.5 mm | | | | | | | | | | | | | | | | | |
| Flame-retardance | + | − | − | − | − | − | − | − | − | − | − | − | − | − | − | − | − |
| stability | | | | | | | | | | | | | | | | | |

BPTMC content means BPTMC unit content in the polycarbonate composition.
Fail indicates that V-2 is not passed.
+ means that the evaluation results of flame-retardancy for 8 or more batches from 10 batches is V0.
− means that the evaluation results of flame-retardancy for less than 8 batches from 10 batches is V0.

### Inventive Examples 1-17 (IE1-IE17)

Similarly, the materials listed in Table 2 were compounded, the physical properties of the compositions obtained were tested and the results are summarized in Table 2.

It can be seen from Table 2 that compositions of inventive examples 1-17 demonstrate a Vicat softening temperature of no less than 152° C., a flame-retardant level of V0, and a good flame-retardance stability

TABLE 2

| | | CE1 | CE2 | CE3 | CE4 | CE5 | CE6 | CE7 | CE8 | CE9 | CE10 | CE11 | CE12 | CE13 | CE14 | CE15 | CE16 | CE17 |
|---|---|---|---|---|---|---|---|---|---|---|---|---|---|---|---|---|---|---|
| Component | | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % |
| A | CoPC | 10 | 20 | 30 | 40 | 50 | 10 | 20 | 30 | 40 | 50 | 60 | 50 | 30 | 50 | 50 | 50 | 50 |
| B | PC | 83.2 | 73.2 | 63.2 | 53.2 | 43.2 | 83.1 | 73.1 | 63.1 | 53.1 | 43.1 | 33.1 | 47.2 | 46.2 | 45.2 | 43.2 | 41.2 | 39.2 |
| C | Bayowet C4 | 0.1 | 0.1 | 0.1 | 0.1 | 0.1 | 0.2 | 0.2 | 0.2 | 0.2 | 0.2 | 0.2 | 0.1 | 0.1 | 0.1 | 0.1 | 0.1 | 0.1 |
| D | E + 308 | 5 | 5 | 3 | 5 | 5 | 5 | 5 | 5 | 5 | 5 | 5 | 1 | 2 | 3 | 5 | 7 | 9 |
| E | ADS5000 | 0.4 | 04 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| F | Pura200 | 0.4 | 04 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| G1 | Faci L348 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| G2 | B900 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| G3 | TIN360 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |

| | | | | | | | | | | | | | | | | | |
|---|---|---|---|---|---|---|---|---|---|---|---|---|---|---|---|---|---|
| BPTMC | 6.9 | 13.8 | 20.8 | 27.7 | 34.6 | 6.9 | 13.8 | 20.8 | 27.7 | 34.6 | 41.5 | 34.6 | 34.6 | 34.6 | 34.6 | 34.6 | 34.6 |
| content (wt %) | | | | | | | | | | | | | | | | | |

Properties

| | | | | | | | | | | | | | | | | | |
|---|---|---|---|---|---|---|---|---|---|---|---|---|---|---|---|---|---|
| Vicat softening | 152 | 158 | 163 | 170 | 176 | 3.52 | 157 | 165 | 170 | 176 | 183 | 175 | 175 | 175 | 175 | 175 | 175 |
| temperatur (□C) | | | | | | | | | | | | | | | | | |
| Izod notched | 60P | 57P | 43P | 23C | 18C | 63P | 57P | 44P | 28C | 17C | 17C | NA | NA | NA | NA | NA | NA |
| impact | | | | | | | | | | | | | | | | | |
| strength | | | | | | | | | | | | | | | | | |
| strength [KJ/m²] | | | | | | | | | | | | | | | | | |
| Flame-retardant | V0 | V0 | V0 | V0 | V0 | V0 | V0 | V0 | V0 | V0 | V0 | V0 | V0 | V0 | V0 | V0 | V0 |
| level at 1.5 mm | | | | | | | | | | | | | | | | | |
| Flame-retardance | + | + | + | + | + | + | + | + | + | + | + | + | + | + | + | + | + |
| stability | | | | | | | | | | | | | | | | | |

BPTMC content means BPTMC unit content in the polycarbonate composition.
+ means that the evaluation results of flame-retardancy for 8 or more batches from 10 batches is V0.
− means that the evaluation results of flame-retardancy for less than 8 batches from 10 batches is V0.
NA: not tested.

### Inventive Examples 18-32 (IE18-IE32) and Comparative Examples 18-20 (CE18-CE20)

Similarly, the materials listed in Table 2 were compounded, the physical properties of the compositions obtained were tested and the results are summarized in Table 3.

It can be seen from Table 3 that compositions of inventive examples 18-32 demonstrate a Vicat softening temperature of no less than 170° C., a flame-retardant level of V0 at 1.5 mm, and a good flame-retardance stability.

Composition of comparative example 18, wherein the CoPC content is 70 wt. % relative to the total weight of the composition, failed in the flame retardance test.

Compositions of comparative examples 19 and 20 not comprising a fluorine-containing metal organic sulfonate show a flame retardant level of V2 at 1.5 mm.

In addition, compositions of inventive examples 27-30 comprising an impact modifier further demonstrate a good impact resistance.

TABLE 3

| | | IE18 | IE19 | IE20 | CE18 | IE21 | IE22 | IE23 | IE24 | IE25 | IE26 | IE27 | IE28 | IE29 | IE30 | CE19 | CE20 | IE31 | IE32 |
|---|---|---|---|---|---|---|---|---|---|---|---|---|---|---|---|---|---|---|---|
| Component | | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % | Wt. % |
| A | CoPC | 40 | 50 | 60 | 70 | 50 | 50 | 50 | 50 | 50 | 50 | 50 | 50 | 50 | 50 | 50 | 50 | 50 | 50 |
| B | PC | 53 | 43 | 33 | 23 | 47 | 46 | 45 | 43 | 41 | 39 | 41.2 | 40.1 | 41 | 39.9 | 43.3 | 43.3 | 43.2 | 43 |
| C | Bayowet C4 | 0.1 | 0.1 | 0.1 | 0.1 | 0.1 | 0.1 | 0.1 | 0.1 | 0.1 | 0.1 | 0.1 | 0.1 | 0.1 | 0.1 | − | − | 0.1 | 0.1 |
| D | E + 308 | 5 | 5 | 5 | 5 | 1 | 2 | 3 | 5 | 7 | 9 | 5 | 5 | 5 | 5 | 5 | 5 | 5 | 5 |
| E | ADS5000 | 0.4 | 0.4 | 0.4 | 0.4 | 0.4 | 0.4 | 0.4 | 0.4 | 0.4 | 0.4 | 0.4 | 0.5 | 0.4 | 0.5 | 0.4 | 0.4 | 0.4 | 0.4 |
| E | Pural200 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| G1 | Faci L348 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| G2 | B900 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| G3 | TIN360 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| G4 | KSS | 0.2 | 0.2 | 0.2 | 0.2 | 0.2 | 0.2 | 0.2 | 0.2 | 0.2 | 0.2 | | | 0.2 | 0.2 | − | − | − | 0.2 |
| G6 | M-732 | − | − | − | − | − | − | − | − | − | − | 2 | − | 2 | − | − | − | − | − |
| G5 | ABS P60 | − | − | − | − | − | − | − | − | − | − | − | 3 | − | 3 | − | − | − | − |

| | | | | | | | | | | | | | | | | | | |
|---|---|---|---|---|---|---|---|---|---|---|---|---|---|---|---|---|---|---|
| BPTMC | 27.7 | 34.6 | 41.5 | 48.5 | 34.6 | 34.6 | 34.6 | 34.6 | 34.6 | 34.6 | 34.6 | 34.6 | 34.6 | 34.6 | 34.6 | 34.6 | 34.6 | 34.6 |
| content (wt. %) | | | | | | | | | | | | | | | | | | |
| Properties | | | | | | | | | | | | | | | | | | |
| Vicat softening | 170 | 176 | 183 | 188 | 175 | 175 | 175 | 175 | 175 | 175 | 175 | 175 | 175 | 175 | 175 | 175 | 175 | 175 |
| temperature (□C) | | | | | | | | | | | | | | | | | | |
| Izod notched | NA | NA | NA | NA | NA | NA | NA | NA | NA | NA | 46P | 51P | 45P | 48P | NA | NA | NA | NA |
| impact | | | | | | | | | | | | | | | | | | |
| strength [KJ/m²] | | | | | | | | | | | | | | | | | | |
| Flame-retardant | V0 | V0 | V0 | Fail | V0 | V0 | V0 | V0 | V0 | V0 | V0 | V0 | V0 | V0 | V2 | V2 | V0 | V0 |
| level at | | | | | | | | | | | | | | | | | | |
| 1.5 mm | | | | | | | | | | | | | | | | | | |
| Flame-retardance | + | + | + | − | + | + | + | + | + | + | + | + | + | + | − | − | + | + |
| Stability | | | | | | | | | | | | | | | | | | |

BPTMC content means BPTMC unit content in the polycarbonate composition.
Fail indicates that V-2 is not passed.
+ means that the evaluation results of flame-retardancy for 8 or more batches from 10 batches is V0.
− means that the evaluation results of flame-retardancy for less than 8 batches from 10 batches is V0.
NA: not tested.

1. A polycarbonate composition comprising the following components A-E, relative to the total weight of the composition:
A) from 8 wt. % to 65 wt. % of a copolycarbonate comprising
i) units of formula (1) 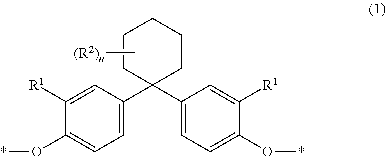
wherein
* indicates the position where formula (1) is connected to a polymer chain,
R¹, each independently, is hydrogen or C₁-C₄ alkyl,
R², each independently, is C₁-C₄ alkyl,
n is 0, 1, 2 or 3, and
ii) units of formula (2): 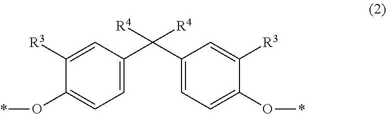
wherein
* indicates the position where formula (2) is connected to the polymer chain,
R³, each independently, is H, linear or branched C₁-C₁₀ alkyl, and
R⁴, each independently, is linear or branched C₁-C₁₀ alkyl;
B) from 30 wt. % to 85 wt. % of a homopolycarbonate comprising units of formula (2) as defined above;
C) from 0.06 wt. % to 0.30 wt. % of a fluorine-containing metal organic sulfonate;
D) from 0.8 wt. % to 10 wt. % of a polysilsesquioxane;
E) from 0.1 wt. % to 0.7 wt. % of an anti-dripping agent; and
F) from 0.1 wt. % to 5 wt. % of a hydrolysis stabilizer,
wherein the hydrolysis stabilizer is selected from the group consisting of mineral clays,
wherein the content by weight of the units of formula (1) in the polycarbonate composition is from 5 wt. % to 50 wt. %, relative to the total weight of the composition.

2. The composition according to claim 1, wherein the copolycarbonate comprises 20-90 mol % of units of formula (1) and 10-80 mol % of units of formula (2), the mol % being calculated based on the total mole number of units of formula (1) and formula (2).

3. The composition according to claim 1, wherein the copolycarbonate does not comprise units derived from a diphenol other than a diphenol of formula (1′) and a diphenol of formula (2′): 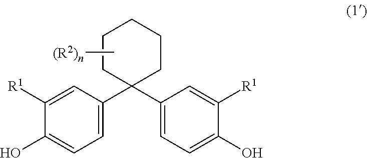
wherein
R¹, each independently, represents hydrogen or C₁-C₄-alkyl,
R², each independently, represents C₁-C₄-alkyl,
n represents 0, 1, 2 or 3; 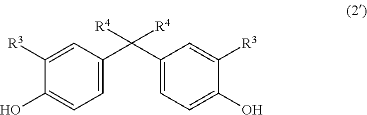
wherein
R³, each independently, represents H, linear or branched C₁-C₁₀ alkyl,
R⁴, each independently, represents linear or branched C₁-C₁₀ alkyl.

4. The composition according to claim 1, wherein the copolycarbonate does not comprise units derived from a diphenol other than bis(4-hydroxyphenyl)-3,3,5-trimethylcyclohexane (BPTMC) and bisphenol A.

5. The composition according to claim 1, wherein the units of formula (2) in the homopolycarbonate are derived from a diphenol of formula (2′): 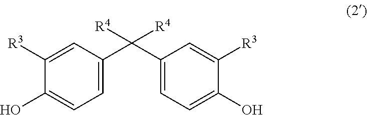
wherein
R³, each independently, represents H, linear or branched C₁-C₄ alkyl, and
R⁴, each independently, represents linear or branched C₁-C₄-alkyl.

6. The composition according to claim 1, wherein the units of formula (2) are derived from bisphenol A.

7. The composition according to any-f claim 1, wherein the fluorine-containing metal organic sulfonate is selected from the group consisting of metal salts of fluorine-containing aliphatic sulfonic acid, metal salts of fluorine-containing aliphatic sulfonimide, and combinations thereof, and the metal in the fluorine-containing metal organic sulfonate is one or more selected from alkali metals such as lithium (Li), sodium (Na), potassium (K), rubidium (Rb) and cesium (Cs); alkali earth metals such as magnesium (Mg), calcium (Ca), strontium (Sr) and barium (Ba); and aluminum (Al), titanium (Ti), iron (Fe), cobalt (Co), nickel (Ni), copper (Cu), zinc (Zn), zirconium (Zr), molybdenum (Mo).

8. The composition according to claim 1, wherein the fluorine-containing metal organic sulfonate is selected from the group consisting of potassium perfluorobutane sulfonate, lithium perfluorobutane sulfonate, sodium perfluorobutane sulfonate, cesium perfluorobutane sulfonate, lithium trifluoromethane sulfonate, sodium trifluoromethane sulfonate, potassium trifluoromethane sulfonate, potassium perfluoroethane sulfonate, potassium perfluoropropane sulfonate, and combinations thereof.

9. The composition according to claim 1, wherein the polysilsesquioxane comprises a trifunctional siloxane unit represented by RSiO_{1.5}, R is selected from hydrogen, C₁-C₁₂ alkyl, C₂-C₁₂ alkenyl, C₁-C₁₂ alkoxy, C₁-C₁₂ acyl, C₃-C₈ cycloalkyl, hydroxy, and phenyl, and contains the unit in an amount of 90% by mol or more of the total siloxane units.

10. The composition according to any claim 1, wherein the anti-dripping agent is selected from polytetrafluoroethylene, polyvinylidene fluoride, tetrafluoroethylene/hexafluoropropylene copolymer, ethylene/tetrafluoroethylene copolymer, and combinations thereof.

11. The composition according to claim 1, wherein the hydrolysis stabilizer is selected from the group consisting of boehmite, kaolin, talc and combinations thereof.

12. The composition according to claim 1, further comprising one or more additional additives selected from lubricants, demoulding agents, antioxidants, dyes, pigments, UV absorbers, impact modifiers, and flame-retardants other than the fluorine-containing metal organic sulfonate.

13. The composition according to claim 1, further comprising a metal salt of aromatic sulfonic acid as flame-retardant.

14. The composition according to claim 1, comprising, relative to the total weight of the composition:
A) 10-60 wt. % of a copolycarbonate comprising
i) 50-90 mol % of units of formula (1a) 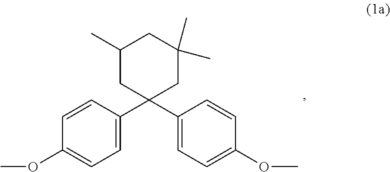
and
ii) 10-40 mol % of units of formula (2a): 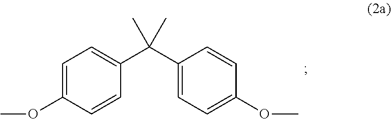
wherein the mol % is calculated based on the total mole number of units of formula (1a) and formula (2a), and
B) from 33-83 wt. % of a homopolycarbonate comprising units of formula (2a),
C) from 0.1 wt. % to 0.2 wt. % of a fluorine-containing metal organic sulfonate, wherein at least potassium perfluorobutane sulfonate is contained as fluorine-containing metal organic sulfonate;
D) from 1 wt. % to 9 wt. % of polysilsesquioxane, wherein polymethylsilsesquioxane is contained as polysilsesquioxane;
E) from 0.2 wt. % to 0.6 wt. % of anti-dripping agent, wherein polytetrafluoroethylene is contained as anti-dripping agent; and
F) from 0.2 wt. % to 0.6 wt. % of boehmite,
wherein the content by weight of the units of formula (1a) in the polycarbonate composition is 6.5-45 wt. %, relative to the total weight of the composition.

15. A shaped article made from the composition according to claim 1.
